(19) United States
(12) Patent Application Publication
(10) Pub. No.: US 2019/0034914 A1
(43) Pub. Date: Jan. 31, 2019

(54) OFFLINE PAYMENT USING VIRTUAL CARD ACCOUNT NUMBER

(71) Applicant: Mastercard International Incorporated, Purchase, NY (US)

(72) Inventors: Jaipal Singh Kumawat, Sikar (IN); Gaurav Kumar, Ahmedabad (IN); Vipul Mehrotra, Sandila (IN)

(21) Appl. No.: 16/041,034

(22) Filed: Jul. 20, 2018

(30) Foreign Application Priority Data
Jul. 25, 2017 (SG) 10201706070T

(51) Int. Cl. G06Q 20/34; G06Q 20/38; G06Q 20/36; G06Q 20/42

(52) U.S. Cl. CPC G06Q 20/351; G06Q 20/42; G06Q 20/3674; G06Q 20/385

(57) ABSTRACT

According to a first aspect, there is provided a digital wallet storage facilitator comprising: at least one processor; at least one memory including computer program code; an input port coupled to the processor; and an output port coupled to the processor; the at least one memory and the computer program code configured to, with the at least one processor, cause the digital wallet storage facilitator at least to: receive, through the input port, a request from a digital wallet application to store a virtual card account number, the virtual card account number being generated from an originating account number to which the virtual card account number is linked; identify an issuer of the originating account number; transmit, through the output port, a query to the issuer to verify the linkage of the virtual card account number to the originating account number; acquire, through the input port, a verification result from the issuer; and convey, through the output port, the verification result to the digital wallet application, whereby the digital wallet application allows the storage of the virtual card account number, in response to a successful verification result.

### CROSS-REFERENCE TO RELATED APPLICATION

This application is a U.S. National Stage filing under 35 U.S.C. § 119, based on and claiming benefits of and priority to Singapore Patent Application No. 10201706070T filed on Jul. 25, 2017. The entire disclosure of the above application is incorporated herein by reference for all purposes.

### FIELD OF INVENTION

The present disclosure relates to a device and method for enabling offline transactions with a virtual card account number.

### BACKGROUND

A virtual card account number is a randomly generated card number associated with an actual payment card. Using the virtual card number in place of the actual payment card for a financial transaction adds a layer of security for the payment card owner since details of the actual payment card account are not revealed to the merchant.

However, virtual cards can only be used for online transactions, i.e. for purchase from websites. Such a limitation excludes virtual card account numbers from being used for offline shopping, such as making purchases from brick and mortar stores. Thus shoppers who are security conscious will have to find another means to pay for offline shopping, such as using cash.

A need therefore exists to find possible solutions that meet the needs of these shoppers.

### SUMMARY

According to a first aspect, there is provided a digital wallet storage facilitator comprising: at least one processor; at least one memory including computer program code; an input port coupled to the processor; and an output port coupled to the processor; the at least one memory and the computer program code configured to, with the at least one processor, cause the digital wallet storage facilitator at least to: receive, through the input port, a request from a digital wallet application to store a virtual card account number, the virtual card account number being generated from an originating account number to which the virtual card account number is linked; identify an issuer of the originating account number; transmit, through the output port, a query to the issuer to verify the linkage of the virtual card account number to the originating account number; acquire, through the input port, a verification result from the issuer; and convey, through the output port, the verification result to the digital wallet application, whereby the digital wallet application allows the storage of the virtual card account number, in response to a successful verification result.

According to a second aspect, there is provided a payment terminal comprising: at least one processor; at least one memory including computer program code; an input port coupled to the processor; and an output port coupled to the processor; the at least one memory and the computer program code configured to, with the at least one processor, cause the payment terminal at least to: receive, through the input port, an authorisation request to fund a transaction using a virtual card account number retrieved by a digital wallet application, the virtual card account number being generated from an originating account number to which the virtual card account number is linked; transmit, through the output port, the authorisation request whereby linkage of the virtual card account number to the originating account number is verified, the authorisation request being intended for an issuer of the originating account number; acquire, through the input port, a result of the authorisation request, whereby successful verification of the linkage authorises funding of the transaction; and transmit, to the digital wallet application, the result of the authorisation request.

According to a third aspect, there is provided a method of enabling payment using a virtual card account number at a payment terminal, the method comprising: receiving, from a digital wallet application, a request to store a virtual card account number, the virtual card account number being generated from an originating account number to which the virtual card account number is linked; identifying an issuer of the originating account number; verifying, with the issuer, the linkage of the virtual card account number to the originating account number; acquiring a verification result from the issuer; and conveying the verification result to the digital wallet application, whereby the digital wallet application allows the storage of the virtual card account number, in response to a successful verification result.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with a present embodiment, by way of non-limiting example only.

Embodiments will be better understood and readily apparent to one of ordinary skill in the art from the following written description, by way of example only, and in conjunction with the drawings, in which:

FIG. 1 shows a block diagram of a system which enables payment using a virtual card account number at a payment terminal.

FIG. 2 shows a flow chart illustrating a computer-implemented method for facilitating offline transactions with a virtual card account number.

FIG. 3 depicts an exemplary computing device 300 that may be used to implement the digital wallet storage facilitator 104 of FIG. 1.

FIG. 4 is a schematic of a computing device that may be utilised to implement the payment terminal shown in FIG. 1.

### DETAILED DESCRIPTION

Embodiments of the present invention will be described, by way of example only, with reference to the drawings. Like reference numerals and characters in the drawings refer to like elements or equivalents.

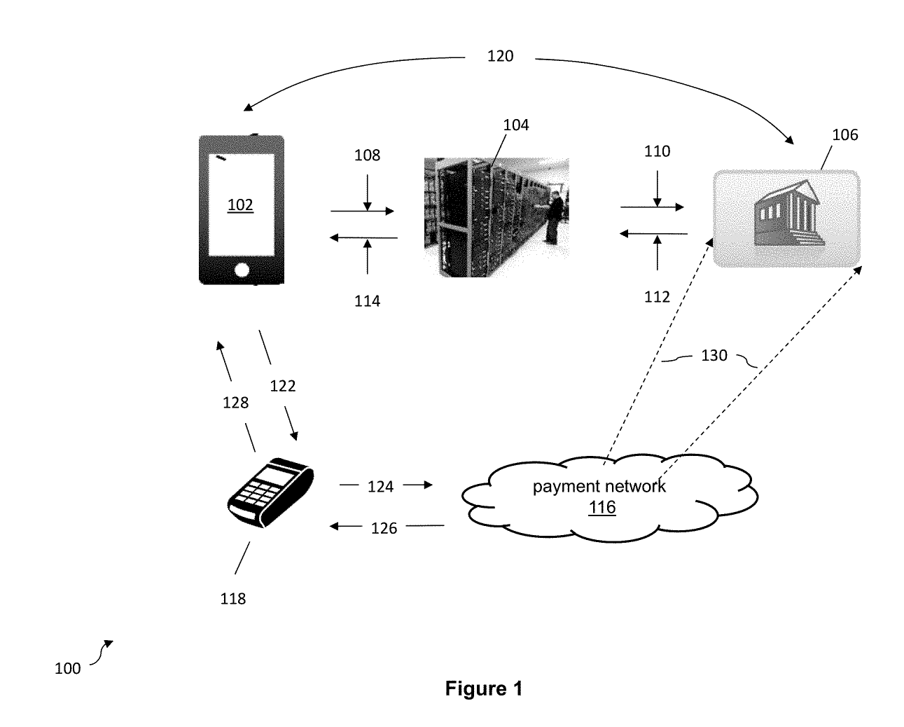

FIG. 1 shows a block diagram of a system 100 which enables payment using a virtual card account number at a payment terminal 118. The term “virtual card account number”, in various implementations disclosed herein, refers to a randomly generated number for making financial transactions, such as purchases from a merchant, a cashback program (where an extra amount added into purchases made at the merchant is obtained in cash, in lieu of having to withdraw the cash from an ATM (automated teller machine) or bank). An account number (hereafter also referred to as an “originating account number”) is needed, to which the randomly generated number is linked, where it is the originating account number that is used to fund the financial transaction. The originating account number is thus an identifier for an account that is opened with a financial institution for banking services like deposit or withdrawal of funds and includes, but is not limited to, a deposit account, a current account or a credit card account.

The virtual card account number avoids having to reveal the originating account number to the merchant, which provides ease of mind to customers who wish to protect their financial details. The virtual card account number may be a 16 digit number resembling a typical credit or debit card account number, where a portion of this 16 digit number (typically the leading 6 digits) is fixed as it is needed to identify the issuer of the virtual card account number, while the remainder is randomly generated. It may have a credit or fund limit set by the issuer or the account holder. The virtual card account may have an expiry date such that it can no longer be used to perform a transaction after the expiry date. The expiry date may be set by the issuer of the virtual card account number or the account holder. When the virtual card account number expires, any remaining unused funds or credit in the virtual card account are credited back to the originating account number.

The system 100 comprises a mobile device 102, in which a digital wallet application is installed, a digital wallet storage facilitator 104, a payment terminal 118 and a payment network 116. The mobile device 102 is in communication with the digital wallet storage facilitator 104 and the payment terminal 118. The digital wallet storage facilitator 104, in turn, is in communication with an issuer server 106. The payment terminal 118 is in communication with the payment network 116 to which the issuer server 106 belongs. Data from the payment terminal 118 intended for the issuer server 106 is routed through one or more entities in the payment network 116 before reaching the issuer server 106, while data from the issuer server 106 intended for the payment terminal 118 is routed back through the same one or more entities. It will be appreciated that when any one of the system 100 components transmits or receives data from another of the system 100 components, the data is routed through one or more computer terminals that are not shown. For instance, data which is transmitted by the digital wallet storage facilitator 104 and intended for the issuer server 106 may be directed through one or more routers before reaching the issuer server 106.

The mobile device 102 is a computing device such as a laptop, palmtop, tablet or a smart mobile phone with an advanced mobile operating system, such as Windows of Microsoft Corporation®, iOS of Apple Inc.® or Android of Google Inc.®. The operating system may host one or more software applications, such as a digital wallet application. When the digital wallet application is installed, the mobile device 102 can be used to store payment card account numbers. The stored payment card account numbers are electronic versions of payment cards that the user of the mobile device 102 owns, such as a credit card, a debit card, a prepaid card, or an ATM (automated teller machine) card. In various implementations disclosed herein, the digital wallet application can also be used to store a virtual card account number that is generated from any one of these payment cards.

This repository function of the digital wallet application, along with its stored account numbers being accessible to built-in features of the mobile device 102 in which the digital application is hosted (such as a near field communication (NFC) or a Bluetooth transmitter), is harnessed to allow the virtual card account number to be used for offline purchases, e.g. through a point of sale (POS) terminal at a merchant store, the POS terminal being equipped with contactless technology like a NFC or a Bluetooth sensor. As the POS terminal can read the virtual account number from the digital wallet application and initiate an authorisation request with the issuer of the virtual account number, the virtual card account number can be used to fund offline purchases, similar to how the other stored payment card account numbers can be used to fund offline purchases. This is advantageous for expanding the possible uses of the virtual card account number, since it is conventionally only used to make online purchases (e.g. from openly accessible internet websites). However, in the conventional approach, the POS terminal is unable to access the virtual account number, so that the virtual card account number is not usable for offline payment. The virtual card account number is stored in a secure element of the mobile device 102 in which the digital application is hosted or in a cloud computing network using host card emulation (HCE), the cloud computing network being in communication with the digital wallet application.

The digital wallet storage facilitator 104 is realised by one or more server terminals to which the digital wallet application in the mobile device 102 is in communication when the digital wallet application is made to store payment card account numbers or a virtual card account number generated from such payment card account numbers. Accordingly, the digital wallet storage facilitator 104 administers requests made by the digital wallet application to store account numbers that can be used to fund financial transactions. The storage is internal (such as in a secure element of the mobile device 102) or external (for example a cloud computing network).

When the digital wallet application is operated to store a virtual card account number, it transmits 108 a request to the digital wallet storage facilitator 104 to initiate a process that effects such storage. A data packet that carries this request may also include a check with the digital wallet storage facilitator 104 as to determine whether the digital wallet application can support financial transactions being funded by the virtual card account number. Such a check is performed to confirm that protocols used when a financial transaction is funded using the virtual card account number are supported by the digital wallet application. This check is mainly to address scenarios where the digital wallet application is developed by a third party, i.e. not the issuer of the virtual card account number. In an alternative implementation, this check may be performed separately from the request to store the virtual card account number, i.e. either before or after the request is transmitted 108.

Upon confirming that the digital wallet application is able to support the virtual card account number, the digital wallet storage facilitator 104 proceeds to identify the issuer of the virtual card account number, which would also be the issuer of the originating account number from which the virtual card account number is generated. The digital wallet storage facilitator 104 performs this identification so as to verify the validity of the virtual card account number with its issuer, which involves determining whether the virtual card account number indeed exists and is linked to a banking account. In one implementation, the virtual card account number may be received encrypted, where an appropriate decryption technique is applied to retrieve the virtual card account number. The digital wallet storage facilitator 104 then analyses the virtual card account number to determine whether any portion provides information on the issuer, such as the leading digits of the virtual card account number. Upon identification of the issuer, the digital wallet storage facilitator 104 transmits 110 a query to the identified issuer to verify the validity of the virtual card account number, which includes verifying whether the linkage of the virtual card account number to its originating account number.

The issuer server 106 is realised by one or more computers (for example, server terminals) that are used to administer data communication with an issuer, such data communication being related to financial services provided by the issuer. These services include creatiing a virtual card account number based on one or more accounts registered to a customer and processing financial transactions that are made using the virtual card account number. These accounts include a deposit account, a current account or a credit card account. The deposit account and current account are traditional banking accounts where funds may be withdrawn up to an amount of existing funds and funds deposited. The credit card account is one issued on behalf of card networks such as MasterCard® or Visa®, where funds may be utilised up to a credit limit.

Upon receiving 110 the query from the digital wallet storage facilitator 104 to verify the validity of the virtual card account number, the issuer server 106 recognises from its format that it is a randomly generated number, whereby the originating account number to which the virtual card account number is linked has to be traced. To trace the originating account number, the issuer server 106 analyses a mapping table that records both virtual card account numbers and originating account numbers, and how these two numbers are mapped (i.e. which originating account number is linked to a virtual card account number or to which originating account number does a virtual card account number belong). In various implementations disclosed herein, the linkage between a virtual card account number and its originating account number is such that any financial transaction funded by the virtual card account number can be redirected to the originating account number for billing. The issuer server 106 then transmits 112 a message containing the verification result of processing the query received from the digital wallet storage facilitator 104 to the digital wallet storage facilitator 104. This verification result may be a successful one, whereby the mapping table has a record of the virtual card account number and its originating account number, or it may be an unsuccessful one where the mapping table has no record of either the virtual card account number or its originating account number.

After the verification result is acquired from the issuer 106, the digital wallet storage facilitator 104 conveys the verification result to the digital wallet application in a message transmitted 114 to the mobile device 102. The digital wallet application is allowed to store the virtual card account number, in response to a successful verification result. The digital wallet application may store the virtual card account number into a secure element of the mobile device 102 or into a cloud computing network (not shown) in communication with the digital wallet application. On the other hand, if the verification result is unsuccessful, the digital wallet application is unable to store the virtual card account number.

The following additional steps may be undertaken to effect storage of the virtual card account number by the digital wallet application. After the issuer server 106 receives 110 the query to verify the validity of the virtual card account number, the issuer server 106 may execute a two factor authentication process with the digital wallet application. For instance, the issuer server 106 may transmit 120 a one-time password to the mobile device 102. The digital wallet application is then made to return 120 this one-time password to the issuer server 106. If the same password is received by the issuer server 106, then the one-time password is validated. As part of the acquisition of the verification result from the issuer server 106 (i.e. the determination as to whether a virtual card account number is linked to an originating account number), the digital wallet storage facilitator is configured to detect completion of such two factor authentication.

After the verification result is sent to the digital wallet application, the issuer server 106 may be configured to communicate, to the digital wallet application, an expiry date of the virtual card account number. This expiry date may be set by the issuer of the originating account number or set during creation of the virtual card account number. The expiry date is provided so that the digital wallet application will execute a command to delete the virtual card account number from storage after the expiry date. Alternatively, or in addition, the digital wallet storage facilitator is further configured to communicate, to the digital wallet application, a predefined number of transactions for which the virtual card account number can fund, for the digital wallet application to execute a command to delete the virtual card account number from storage after the predefined number of transactions is reached. Similar to the card expiry date scenario, the predefined number of transactions may be set by the issuer of the originating account number or set during creation of the virtual card account number. This thus limits the number of transactions that the virtual card account number can fund. Accordingly, the digital wallet application erases the virtual card account number when either the expiry date or a total number of transactions occurs first. Such automatic deletion at the digital wallet application saves processing time compared to the scenario where the digital wallet application initiates an authorisation sequence on a virtual card account number only to be informed by the issuer server 106 that the virtual card account number is no longer valid.

Before the virtual card account number can be used to fund financial transactions, it has to created. Creation of the virtual card account number may be done as follows. An owner of one or more payment card accounts maintained by the issuer server 106 logs into his personal account via, for example, an internet banking portal hosted by the issuer server 106. The owner then selects one of the payment card accounts that can support virtual card account number linkage, to base generation of a virtual card account number, whereby the selected payment account number then becomes an originating account number as described above. The expiry date of the virtual card account number and/or the maximum number of transactions over which the virtual card account number can be used may be specified during its creation, whereby the virtual card account number is then flushed from the issuer server 106 after the expiry date or the maximum number of transactions is reached, whichever occurs first. The virtual card account and the originating account number are then stored in the mapping table mentioned above. The virtual card account number can then be entered into the digital wallet application for storage as described above.

Funding of a financial transaction, such as purchase of a good or a service from a merchant, using the virtual card account number may occurs as follows.

During checkout, the digital wallet application in the mobile device 102 is started and the virtual card account number is selected to fund the financial transaction. The mobile device 102 is then brought into proximity to a payment terminal 118 operated by the merchant.

The payment terminal 118, or known as a point of sale (POS) device, is a standalone device or may be a terminal that is part of a system that includes a computer, a cash register and other equipment that supports functions like inventory management and integration with merchant backend components. The payment terminal 118 is used to interface with payment cards, such as credit, debit, stored value or ATM cards. The payment terminal may also include a NFC (Near Field Communication) or Bluetooth transceiver that receives and transmits data from and to the digital wallet application hosted in the mobile device 102.

When the payment terminal 118 detects that the digital wallet application is in proximity during checkout, the payment terminal 118 will obtain the virtual card account number from the digital wallet application. The virtual card account number is retrieved by the digital wallet application either from the secure element of the mobile device 102 or from a cloud computing network in communication with the digital wallet application.

The transmission 122 of the virtual card account number to the payment terminal 118 initiates an authorisation request to fund the financial transaction using the virtual card account number retrieved by the digital wallet application. The payment terminal 118 will not realise that the virtual card account number is not an actual account number, but rather a pointer to an originating account number from which the virtual card account number is generated and to which the virtual card account number is linked. However, the payment terminal 118 will realise that the virtual card account number originates from an issuer, to which the virtual card account number needs to be routed for the authorisation request to be approved. This realisation is reached from the payment terminal 118 detecting that the virtual card account number belongs to a reserved number range. For example the payment terminal 118 analyses the virtual card account number to determine whether any portion provides information on the issuer, such as the leading digits of the virtual card account number, the payment terminal 118 is able to determine a payment network 116 through which the virtual card account needs to be routed to reach the issuer.

The payment network 116 refers to a network of computers which route and process electronic transaction messages when making electronic payment using a payment card. The network of computers may thus include computer systems used to implement the four party model used by Visa® or MasterCard® to process a payment transaction made using their card. The notable (but not necessarily only) components of the payment network 116 thus include an acquirer (to which the payment terminal 118 is in communication), the issuer and a switch that routes information between the acquirer and the issuer. In FIG. 1, only the issuer (represented by the issuer server 106) is shown for the sake of simplicity, where the dotted arrows labelled with reference numeral 130 is used to denote that the issuer server 106 is part of the payment network 116. The rest of the components of the payment network 116 are not further elaborated upon.

The payment terminal 118 transmits 124 the authorisation request to the payment network 116. The authorisation request is intended for the issuer of the virtual card account number, which is also the issuer of the originating account number to which the virtual card account number is linked, so that this linkage can be verified.

The authorisation request is routed to the issuer server 106 through the payment network 116. When the issuer server 106 receives the authorisation request to fund the financial transaction using the virtual card account number retrieved by the digital wallet application, the issuer server 106 seeks to verify the linkage of the virtual card account number to the originating account number. The issuer server 106 then routes a result of the authorisation request to the payment terminal 118 through the payment network 116. A successful verification of the linkage, along with confirming the originating account number has sufficient funds for the financial transaction, authorises funding of the financial transaction. On the other hand, if the issuer server 106 has no record of the virtual card account number or if there is indeed such a virtual card account number, but insufficient funds in the originating account number to which the virtual card account number is linked, the authorisation request is declined. Additional checks that may be performed at the issuer server 106 include determining whether the authorisation request is made before an expiry date of the virtual card account number; or/and whether the authorisation request is within a predefined number of transactions for which the virtual card account number can fund.

The payment terminal 118 acquires the result of the authorisation request in a data packet received 126 from the payment network 116. The payment terminal 118 then transmits 128 the result of the authorisation request to the digital wallet application via the mobile device 102.

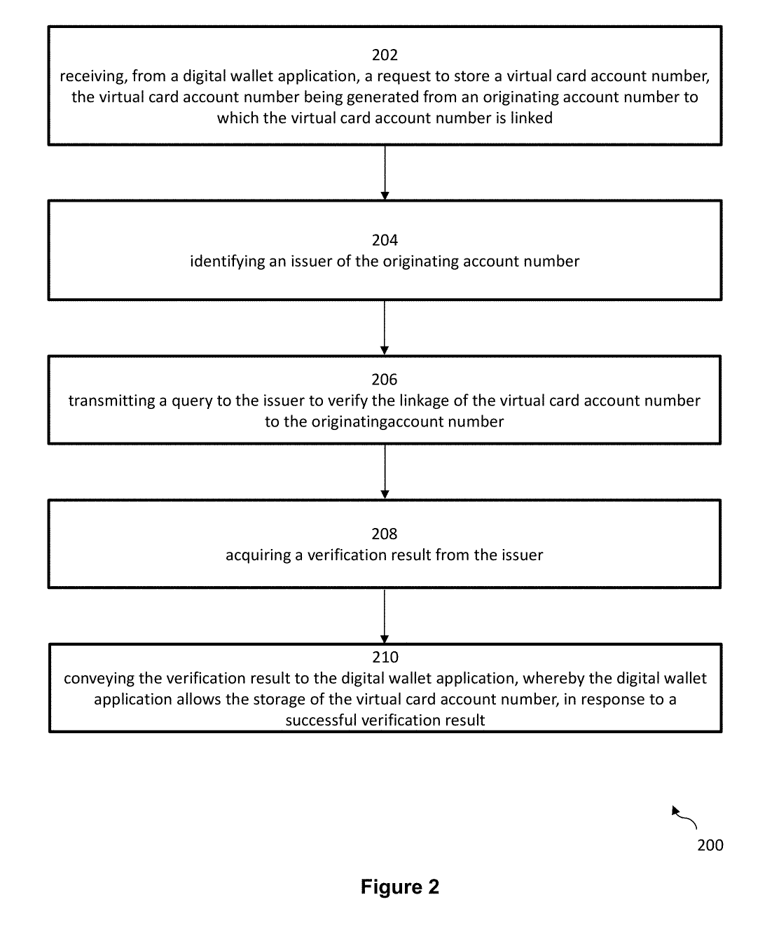

FIG. 2 shows a flow chart 200 illustrating a computer-implemented method for facilitating offline transactions with a virtual card account number.

Referring to FIG. 2, at step 202, a request is received from a digital wallet 102 application to store a virtual card account number, the virtual card account number being generated from an originating account number to which the virtual card account number is linked.

At step 204, an issuer 106 of the originating account number is identified.

At step 206, a query is transmitted to the issuer to verify the linkage of the virtual card account number to the originating account number.

At step 208, a verification result is acquired from the issuer. At step 210, the verification result is conveyed to the digital wallet 102 application, whereby the digital wallet 102 application allows the storage of the virtual card account number, in response to a successful verification result.

The computer-implemented method may include further steps which are not shown in FIG. 2, but are described below.

For example, the virtual card account number is created before the step 202 by selecting, at the issuer, a payment card account that can support virtual card account number linkage to base generation of the virtual card account number.

The digital wallet application of step 202 is downloaded, for example from an application repository, such as Google® Play.

During acquisition of the verification result from the issuer, it is detected whether two factor authentication has been completed. The two factor authentication may involve validation of a one-time password transmitted from the digital wallet application.

The virtual card account number is stored into a secure element of a mobile device in which the digital wallet application is hosted or into a cloud computing network in communication with the digital wallet application.

When a financial transaction using the virtual card account number occurs, the method further includes receiving, at the issuer, an authorisation request to fund a transaction using the virtual card account number retrieved by the digital wallet application; verifying the linkage of the virtual card account number to the originating account number; and transmitting a result of the authorisation request, whereby successful verification of the linkage authorises funding of the transaction. Further steps include determining, at the issuer, that the authorisation request is made before an expiry date of the virtual card account number or/and determining, at the issuer, that the authorisation request is within a predefined number of transactions for which the virtual card account number can fund

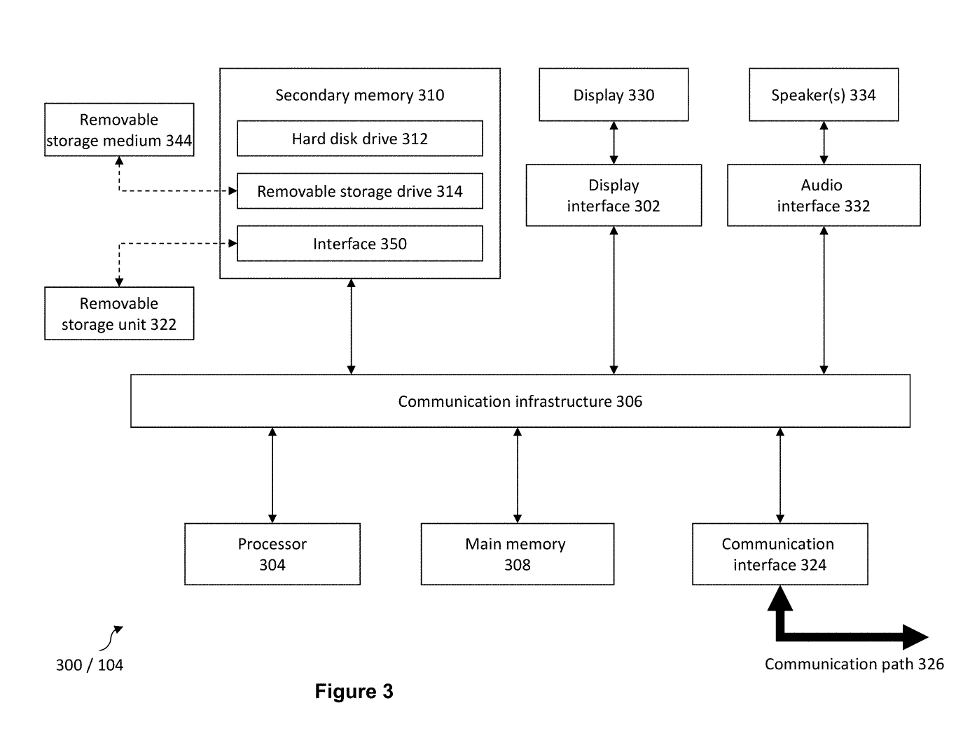

FIG. 3 depicts an exemplary computing device 300 that may be used to implement the digital wallet storage facilitator 104 of FIG. 1. The following description of the computing device 300 is provided by way of example only and is not intended to be limiting.

As shown in FIG. 3, the example computing device 300 includes a processor 304 for executing software routines. Although a single processor is shown for the sake of clarity, the computing device 300 may also include a multi-processor system. The processor 304 is connected to a communication infrastructure 306 for communication with other components of the computing device 300. The communication infrastructure 306 may include, for example, a communications bus, cross-bar, or network.

The computing device 300 further includes a main memory 308, such as a random access memory (RAM), and a secondary memory 310. The secondary memory 310 may include, for example, a storage drive 312, which may be a hard disk drive, a solid state drive or a hybrid drive and/or a removable storage drive 314, which may include a magnetic tape drive, an optical disk drive, a solid state storage drive (such as a USB flash drive, a flash memory device, a solid state drive or a memory card), or the like. The removable storage drive 314 reads from and/or writes to a removable storage medium 344 in a well-known manner. The removable storage medium 344 may include magnetic tape, optical disk, non-volatile memory storage medium, or the like, which is read by and written to by removable storage drive 314. As will be appreciated by persons skilled in the relevant art(s), the removable storage medium 344 includes a computer readable storage medium having stored therein computer executable program code instructions and/or data.

In an alternative implementation, the secondary memory 310 may additionally or alternatively include other similar means for allowing computer programs or other instructions to be loaded into the computing device 300. Such means can include, for example, a removable storage unit 322 and an interface 350. Examples of a removable storage unit 322 and interface 350 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 322 and interfaces 350 which allow software and data to be transferred from the removable storage unit 322 to the computing device 300.

The computing device 300 also includes at least one communication interface 324. The communication interface 324 allows software and data to be transferred between computing device 300 and external devices via a communication path 326. In various embodiments, the communication interface 324 permits data to be transferred between the computing device 300 and a data communication network, such as a public data or private data communication network. The communication interface 324 may be used to exchange data between different computing devices 300 which such computing devices 300 form part an interconnected computer network. Examples of a communication interface 324 can include a modem, a network interface (such as an Ethernet card), a communication port (such as a serial, parallel, printer, GPIB, IEEE 1394, RJ45, USB), an antenna with associated circuitry and the like. The communication interface 324 may be wired or may be wireless. Software and data transferred via the communication interface 324 are in the form of signals which can be electronic, electromagnetic, optical or other signals capable of being received by communication interface 324. These signals are provided to the communication interface via the communication path 326.

As shown in FIG. 3, the computing device 300 further includes a display interface 302 which performs operations for rendering images to an associated display 330 and an audio interface 332 for performing operations for playing audio content via associated speaker(s) 334.

As used herein, the term “computer program product” may refer, in part, to removable storage medium 344, removable storage unit 322, a hard disk installed in storage drive 312, or a carrier wave carrying software over communication path 326 (wireless link or cable) to communication interface 324. Computer readable storage media refers to any non-transitory, non-volatile tangible storage medium that provides recorded instructions and/or data to the computing device 300 for execution and/or processing. Examples of such storage media include magnetic tape, CD-ROM, DVD, Blu-Ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 300. Examples of transitory or non-tangible computer readable transmission media that may also participate in the provision of software, application programs, instructions and/or data to the computing device 300 include radio or infra-red transmission channels as well as a network connection to another computer or networked device, and the Internet or Intranets including e-mail transmissions and information recorded on Websites and the like.

The computer programs (also called computer program code) are stored in main memory 308 and/or secondary memory 310. Computer programs can also be received via the communication interface 324. Such computer programs, when executed, enable the computing device 300 to perform one or more features of embodiments discussed herein. In various embodiments, the computer programs, when executed, enable the processor 304 to perform features of the above-described embodiments. Accordingly, such computer programs represent controllers of the computing device 300.

Software may be stored in a computer program product and loaded into the computing device 300 using the removable storage drive 314, the storage drive 312, or the interface 350. The computer program product may be a non-transitory computer readable medium. Alternatively, the computer program product may be downloaded to the computing device 300 over the communications path 326. The software, when executed by the processor 304, causes the computing device 300 to perform functions of embodiments described herein.

It is to be understood that the embodiment of FIG. 3 is presented merely by way of example. Therefore, in some embodiments one or more features of the computing device 300 may be omitted. Also, in some embodiments, one or more features of the computing device 300 may be combined together. Additionally, in some embodiments, one or more features of the computing device 300 may be split into one or more component parts.

When the computing device 300 is used to implement the digital wallet storage facilitator 104, the communication interface 324 provides the input port and the output port of the digital wallet storage facilitator 104. The at least one memory 308, 310 and the computer program code are configured to, with the at least one processor 304, cause the digital wallet storage facilitator 104 at least to: receive, through the input port, a request from a digital wallet application to store a virtual card account number, the virtual card account number being generated from an originating account number to which the virtual card account number is linked. The digital wallet storage facilitator 104 is then caused to identify an issuer of the originating account number and transmit, through the output port, a query to the issuer to verify the linkage of the virtual card account number to the originating account number. The digital wallet storage facilitator 104 then acquires, through the input port, a verification result from the issuer and conveys, through the output port, the verification result to the digital wallet application, whereby the digital wallet application allows the storage of the virtual card account number, in response to a successful verification result.

Any one of the memory 308, 310 or the removable storage 344, 322 provides a non-transitory computer readable medium in which is stored instructions that when executed performs the method of FIG. 2. Accordingly, the digital wallet storage facilitator 104 contains a non-transitory computer readable medium in which is stored instructions that when executed causes the digital wallet storage facilitator 104 to receive, from a digital wallet application, a request to store a virtual card account number, the virtual card account number being generated from an originating account number to which the virtual card account number is linked; identify an issuer of the originating account number; verify, with the issuer, the linkage of the virtual card account number to the originating account number; acquire a verification result from the issuer; and convey the verification result to the digital wallet application, whereby the digital wallet application allows the storage of the virtual card account number, in response to a successful verification result.

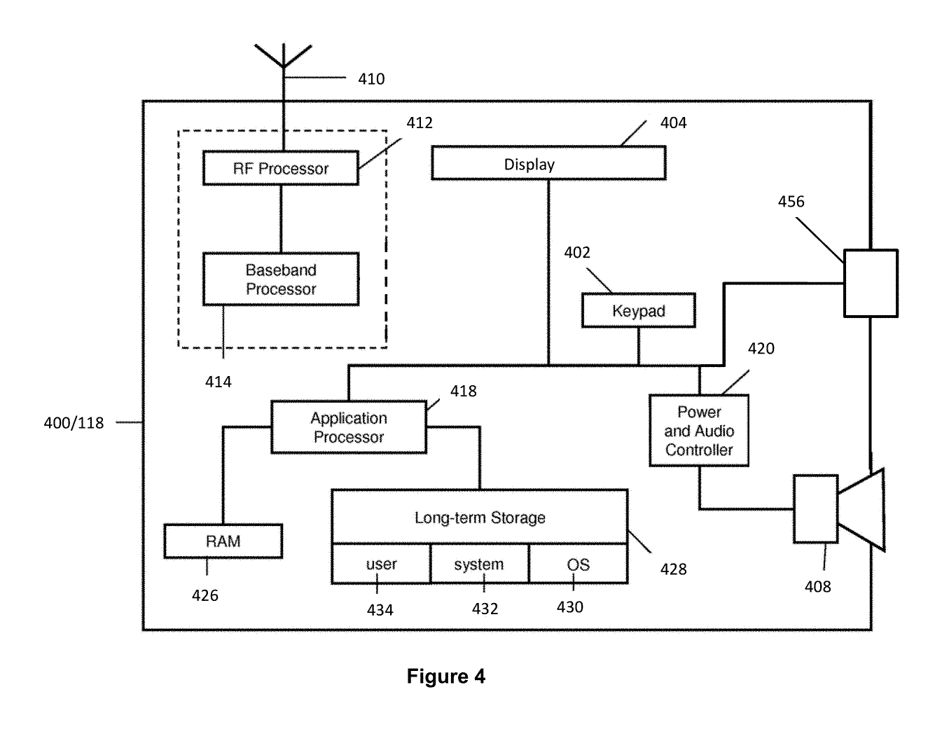

FIG. 4 is a schematic of a computing device 400 that may be utilised to implement the payment terminal 118 shown in FIG. 1.

The computing device 400 comprises a keypad 402, a display 404, a speaker 408 and an antenna 410. Communication hardware that is used to enable NFC or Bluetooth communication is represented by RF processor 412 which provides an RF signal to the antenna 410 for the transmission of data signals, and the receipt therefrom. Additionally provided is a baseband processor 414, which provides signals to and receives signals from the RF Processor 412.

The keypad 402 and the display 404 are controlled by an application processor 418. The display 404 is used to provide an indication of the status of the payment terminal 118, such as payment options available when the payment terminal 118 detects that it is being used to receive electronic payment or that the payment terminal 118 is processing payment after a payment option is selected through the keypad 402. A power and audio controller 420 is provided to supply power to the RF processor 412 and the baseband processor 414, the application processor 418, and other hardware. The power and audio controller 420 also controls audio output via the speaker 408. The speaker 408 is used to provide sounds to indicate that a data transaction with the payment terminal 118 has been successfully completed.

In order for the application processor 418 to operate, various different types of memory are provided. Firstly, the computing device 400 includes Random Access Memory (RAM) 426 connected to the application processor 418 into which data and program code can be written and read from at will. Code placed anywhere in RAM 426 can be executed by the application processor 418 from the RAM 426. RAM 426 represents a volatile memory of the computing device 400.

Secondly, the computing device 400 is provided with a long-term storage 428 connected to the application processor 418. The long-term storage 428 comprises three partitions, an operating system (OS) partition 430, a system partition 432 and a user partition 434. The long-term storage 428 represents a non-volatile memory of the computing device 400.

In the present example, the OS partition 430 contains the firmware of the computing device 400 which includes an operating system. Other computer programs may also be stored on the long-term storage 428, such as application programs, and the like. In particular, application programs which are mandatory to the computing device 400 are typically stored in the system partition 432. The application programs stored on the system partition 432 would typically be those which are bundled with the computing device 400 by the device manufacturer when the computing device 400 is first sold. Application programs which are added to the computing device 400 by the user would usually be stored in the user partition 434. The computing device 400 also includes a communication port 456, through which the computing device 400 receives or sends data in respect of processed electronic payment.

When the computing device 400 is used to implement the payment terminal 118, the communication port 456 provides the input port and the output port of the payment terminal 118. The at least one processor (e.g. application processor 418) and the at least one memory (e.g. RAM 426, long-term storage 428) with its computer program code are configured to cause the payment terminal 118 at least to receive, through the input port, an authorisation request to fund a transaction using a virtual card account number retrieved by a digital wallet application, the virtual card account number being generated from an originating account number to which the virtual card account number is linked. The at least one memory and the computer program code are further configured to, with the at least one processor, transmit, through the output port, the authorisation request whereby linkage of the virtual card account number to the originating account number is verified, the authorisation request being intended for an issuer of the originating account number. The payment terminal 118 will then be caused to acquire, through the input port, a result of the authorisation request, whereby successful verification of the linkage authorises funding of the transaction; and transmit, to the digital wallet application, the result of the authorisation request.

Instructions may be stored in any one or more of the RAM 426 or the long-term storage 428. These components 426 and 428 provide a non-transitory computer readable medium having stored thereon executable instructions for controlling the payment terminal 118 to perform steps comprising: a) receiving, through the input port, an authorisation request to fund a transaction using a virtual card account number retrieved by a digital wallet application, the virtual card account number being generated from an originating account number to which the virtual card account number is linked; b) transmitting, through the output port, the authorisation request whereby linkage of the virtual card account number to the originating account number is verified, the authorisation request being intended for an issuer of the originating account number transmit, through the output port, the authorisation request whereby linkage of the virtual card account number to the originating account number is verified, the authorisation request being intended for an issuer of the originating account number; c) acquiring, through the input port, a result of the authorisation request, whereby successful verification of the linkage authorises funding of the transaction; and d) transmitting, to the digital wallet application, the result of the authorisation request.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A digital wallet storage facilitator comprising:
at least one processor;
at least one memory including computer program code;
an input port coupled to the processor; and
an output port coupled to the processor;
the at least one memory and the computer program code configured to, with the at least one processor, cause the digital wallet storage facilitator at least to:
receive, through the input port, a request from a digital wallet application to store a virtual card account number, the virtual card account number being generated from an originating account number to which the virtual card account number is linked;
identify an issuer of the originating account number;
transmit, through the output port, a query to the issuer to verify the linkage of the virtual card account number to the originating account number;
acquire, through the input port, a verification result from the issuer; and
convey, through the output port, the verification result to the digital wallet application, whereby the digital wallet application allows the storage of the virtual card account number, in response to a successful verification result.

2. The digital wallet storage facilitator of claim 1, wherein the digital wallet storage facilitator is further configured to detect completion of two factor authentication during acquisition of the verification result from the issuer.

3. The digital wallet storage facilitator of claim 2, wherein the two factor authentication comprises validation of a one-time password transmitted from the digital wallet application.

4. The digital wallet storage facilitator of claim 1, wherein the originating account is for financial transactions and comprises any one of a deposit account, a current account or a credit card account.

5. The digital wallet storage facilitator of claim 1, wherein the digital wallet storage facilitator is further configured to communicate, to the digital wallet application, an expiry date of the virtual card account number for the digital wallet application to execute a command to delete the virtual card account number from storage after the expiry date.

6. The digital wallet storage facilitator of claim 1, wherein the digital wallet storage facilitator is further configured to communicate, to the digital wallet application, a predefined number of transactions for which the virtual card account number can fund, for the digital wallet application to execute a command to delete the virtual card account number from storage after the predefined number of transactions is reached.

7. A payment terminal comprising:
at least one processor;
at least one memory including computer program code;
an input port coupled to the processor; and
an output port coupled to the processor;
the at least one memory and the computer program code configured to, with the at least one processor, cause the payment terminal at least to:
receive, through the input port, an authorisation request to fund a transaction using a virtual card account number retrieved by a digital wallet application, the virtual card account number being generated from an originating account number to which the virtual card account number is linked;
transmit, through the output port, the authorisation request whereby linkage of the virtual card account number to the originating account number is verified, the authorisation request being intended for an issuer of the originating account number;
acquire, through the input port, a result of the authorisation request, whereby successful verification of the linkage authorises funding of the transaction; and
transmit, to the digital wallet application, the result of the authorisation request.

8. The payment terminal of claim 7, wherein the payment terminal is further configured to detect that the virtual card account number belongs to a reserved number range.

9. A method of enabling payment using a virtual card account number at a payment terminal, the method comprising:
receiving, from a digital wallet application, a request to store a virtual card account number, the virtual card account number being generated from an originating account number to which the virtual card account number is linked;
identifying an issuer of the originating account number;
verifying, with the issuer, the linkage of the virtual card account number to the originating account number;
acquiring a verification result from the issuer; and
conveying the verification result to the digital wallet application, whereby the digital wallet application allows the storage of the virtual card account number, in response to a successful verification result.

10. The method of claim 9, wherein the method further comprises
detecting for completion of two factor authentication during acquisition of the verification result from the issuer.

11. The method of claim 10, wherein the two factor authentication comprises validation of a one-time password transmitted from the digital wallet application.

12. The method of claim 9, further comprising
storing the virtual card account number into a secure element of a mobile device in which the digital wallet application is hosted or into a cloud computing network in communication with the digital wallet application.

13. The method of claim 9, further comprising
receiving, at the issuer, an authorisation request to fund a transaction using the virtual card account number retrieved by the digital wallet application;
verifying the linkage of the virtual card account number to the originating account number; and
transmitting a result of the authorisation request, whereby successful verification of the linkage authorises funding of the transaction.

14. The method of claim 13, further comprising
determining, at the issuer, that the authorisation request is made before an expiry date of the virtual card account number.

15. The method of claim 13, further comprising
determining, at the issuer, that the authorisation request is within a predefined number of transactions for which the virtual card account number can fund.
